(19) United States
(12) Patent Application Publication
(10) Pub. No.: US 2015/0231588 A1
(43) Pub. Date: Aug. 20, 2015

(54) MICROCAPSULES

(71) Applicants: Rohm and Haas Company, Philadelphia, PA (US); The Board of Trustees of the University of Illinoi, Champaign, IL (US)

(72) Inventors: Jeffery S. Moore, Savoy, IL (US); Jun Li, Champaign, IL (US); Andrew Hughes, Richboro, PA (US)

(21) Appl. No.: 14/624,411

(22) Filed: Feb. 17, 2015

Related U.S. Application Data
(60) Provisional application No. 61/941,066, filed on Feb. 18, 2014.

(51) Int. Cl. B01J 13/16; B01J 13/18; C08G 59/18; C08K 3/34; C08G 59/50

(52) U.S. Cl. CPC B01J 13/16; C08K 3/346; C08G 59/502; C08G 59/188; B01J 13/185

(57) ABSTRACT

Microcapsules including a shell and core structure are disclosed herein. In one aspect, the core includes at least one poly(allylamine). A process for producing such microcapsules is also disclosed herein. In another aspect, a curable epoxy resin composition includes a mixture of (a) at least one epoxy monomer compound and (b) a plurality of the disclosed microcapsules. Processes for producing the curable epoxy resin composition and a cured epoxy resin composite are also disclosed.

### CROSS-REFERENCE TO RELATED APPLICATIONS

The present application claims priority to U.S. Provisional Patent Application No. 61/941,066 filed on Feb. 18, 2014, the content of which is incorporated herein by reference in its entirety.

### FIELD

The present application generally relates to microencapsulation products or microcapsules. More particularly but not exclusively, the present application relates to microencapsulation products or microcapsules which include a shell and core structure that includes at least one poly(allylamine). In one aspect, the presence of the poly(allylamine) in the core structure promotes or results in an extended shelf-life of the microencapsulation products or microcapsules.

### BACKGROUND

Encapsulation methods used to produce microcapsules are known in the art. A known encapsulation method, includes for example, an interfacial polymerization process as disclosed in International Patent Publication No. WO 2012/166884 A2. As an illustration, using interfacial polymerization a microcapsule can be fabricated having a layer of a shell wall around a polar core material of an active material.

Microcapsules produced by various encapsulation methods may be thermally and mechanically stable, and can be stored for use at a later time period. Thus, in one form for example the microcapsules can provide an on-demand activation system which can respond to stimuli, such as mechanical shearing, to rupture the core and release the active material in the core for the active material to function. For example, an amine useful as the core material can function as a curing agent for thermosetting resins. The microcapsules, intact, can be contacted with a thermosetting resin such as an epoxy resin, and when activation of the microcapsules is desired, the microcapsules can be activated, or ruptured, by applying a high shear force to the microcapsules to rupture the shell of the microcapsules. Upon rupturing the shell of the microcapsules, the previously-encapsulated amine is released to function for its intended purpose, for example to cure the epoxy resin coming in contact with the released amine to form a thermoset.

However, the release of the amine from the core of the microcapsules is not limited to instances where mechanical stimulus is applied to the microcapsules. Rather, it has been observed that release of the amine may also occur via leakage (or “bleeding”) during storage of the microcapsules as well as by diffusion through the intact shell. Release of the amine from the microcapsules during storage may be due to defects and pores in the shell material of the microcapsules which results from swelling of the shell wall and diffusion of the encapsulated liquids into the shell wall. In instances where the microcapsules are combined with a thermosetting resin such as epoxide monomers and stored for later on-demand activation and the amine is released from the microcapsules during storage, unintended curing of the epoxide monomers in contact with the released amine occurs. Such curing of the thermosetting resin can occur within a short period of time (e.g., as short as two weeks) deleteriously affecting the use of such microcapsules.

In view of the foregoing, additional contributions in this area of technology are needed. For example, microcapsules which prevent unintended release of a material are desirable. International Patent Publication No. WO 2012/166884 A2 discloses an encapsulation method for producing microcapsules which encapsulate polar active materials such as aliphatic amines. The amine-core microcapsules prepared according to the encapsulation method disclosed in International Patent Publication No. WO 2012/166884A2 can be mixed with an epoxide monomer, for example a commercial epoxy resin such as D.E.R. 331 (commercially available from The Dow Chemical Company), to form a curable composition.

The curable composition is useful, for example, in protective coating applications. These microcapsules can provide, amongst other things, an on-demand activation system which can respond to stimuli, such as mechanical shearing, so as to cure the curable composition.

### SUMMARY

In one aspect, a shell-forming aliphatic amine is identified, such as for example a poly(allylamine) [pAAM], that can be used in conjunction with other aliphatic amines to form shells. Although not bound to any particular theory herein, it is believed that the pAAM may be the primary shell-forming species because of the surface activity of the pAAM and its tendency to concentrate at the emulsion droplet interface. In addition, since the pAAM additive is the primary shell-former, the polyurea polymers in the shell exhibit high molecular weight and extensive crosslinking properties. These properties contribute to enhancing mechanical integrity and to lowering the rates of through-shell molecular diffusion, thereby extending the shelf-life of the amine-core microcapsules mixed with epoxy resin when the microcapsules are prepared using a pAAM/amine curing agent mixture.

As used herein, “shelf-life” refers to the preservation of the microcapsules integrity, the prevention of core leakage, and the minimization of through-shell diffusion of active material out of the microcapsule. Extending the shelf-life of microcapsules is beneficial since it results in microcapsules which are stable for handling and storing until the microcapsules are needed for an end use application.

In one aspect, the extension of the shelf-life of amine-core microcapsules so that the amine-core microcapsules can be combined with thermosetting monomers such as epoxide monomers is provided. In this manner, the combination can be stored for a period of time until the combination mixture can be used later, such as for example, to be activated on-demand for various applications including for example protective coating applications.

In another aspect, microcapsules of encapsulated polar materials, such as amines, which exhibit a longer shelf-life (e.g., beyond a two-week period) are provided.

In addition, the microcapsules disclosed herein avoid (in whole or in part) leakage that leads to the premature release of amine from the microcapsules' core that may result in the premature curing of the composition containing the microcapsules.

For example, the shelf-life of a composition including a mixture of microcapsules and monomers can be extended by incorporating a poly(allylamine) in the material encapsulated in the core of the microcapsule. In other words, in one aspect a distinct shelf-life extension effect is derived from the usage of a poly(allylamine). In addition, a relatively low dosage of poly(allylamine) (e.g., less than about 1 percent [%] mass equivalent of the target amine) can be used in a curable composition to suppress undesirable leakage. The preservation (shelf-life) of the microcapsules can be observed by the viscosity change of a curable composition containing such microcapsules. For example, a composition exhibiting an enhanced shelf-life is provided where the viscosity of the composition remains at five to six times that of the composition's initial viscosity after about 700 hours (or approximately a month). The encapsulated amines and the epoxide in the composition can be confirmed to be active after storage by demonstrating that the microcapsules still exhibit the capability of activating the composition after storing the composition for at least about 700 hours (hr) or more.

Although not intending to bound to any particular theory herein, it is contemplated that a poly(allylamine) may aggregate at the interface of polar and non-polar components during the formation of a Pickering emulsion, functioning as a macromolecular amphiphile. Being readily accessible to polyisocyanates, the poly(allylamine) then actively participates in the interfacial condensation polymerization, allowing good stoichiometric matching (i.e., the number of isocyanates in the isocyanate monomer and the number of amines in the poly(allylamine) additive is closer to 1:1 than the number of isocyanates in the isocyanate monomer and the number of amines in the amine curing agent) of the amine. The extension of shelf-life of the amine-core microcapsules and epoxide monomer composites is believed to be a consequence of the resultant cross-linked, high molecular weight shell wall, upon subsequent interfacial polymerization, which limits the swelling of the shell wall through diffusion and the mechanical rupture of the microcapsules and, in turn, prevents the leaking of the core material.

In one embodiment, a plurality of microcapsules include a shell and core structure. The shell of the microcapsules includes a polymer matrix adapted for providing an extended shelf-life to the microcapsules. The polymer matrix of the shell is prepared by a process which includes contacting a non-polar liquid with a highly polar liquid adapted for forming an interface of an emulsion or suspension of the highly polar liquid in the nonpolar liquid. The core of the microcapsules includes an active material and/or the highly polar liquid, and the active material comprises at least one poly(allylamine).

In another embodiment, a curable resin composition includes a mixture of (a) the above plurality of microcapsules; and (b) at least one thermosetting compound. For example, the thermosetting compound of the curable resin composition can be an epoxy resin composition containing one or more epoxy monomer compounds.

Other embodiments are directed to processes for preparing the above microcapsules and the above curable epoxy resin composition.

Microcapsule durability is a property that enables the use of microcapsules in other applications where shelf-life is important such as use in self-healing materials and delivery of amine compounds for biocidal, agricultural, or pharmaceutical applications.

Further aspects, embodiments, forms, features, benefits, objects and advantages shall become apparent from the detailed description provided herewith.

### BRIEF DESCRIPTION OF THE DRAWINGS

FIG. 1 is a cross-sectional view of one embodiment of a microcapsule.

FIG. 2 is a schematic view of one non-limiting encapsulation method for forming a microcapsule.

FIG. 3 is a graphical illustration comparing normalized viscosity of various resin compositions containing microcapsules disclosed herein.

### DETAILED DESCRIPTION

For purposes of promoting an understanding of the invention, reference will now be made to the following embodiments and specific language will be used to describe the same. It will nevertheless be understood that no limitation of the scope of the invention is thereby intended, such alterations and further modifications in the described subject matter, and such further applications of the principles of the invention as described herein being contemplated as would normally occur to one skilled in the art to which the invention relates.

The examples given in the definitions are generally non-exhaustive and must not be construed as limiting the invention disclosed in this document.

“Shelf-life” as used herein, with reference to a microcapsule, means the time it takes for a mixture which includes an epoxy resin and amine microcapsules to become a gel.

“Mechanical stability” as used herein, with reference to a microcapsule, means the propensity of a capsule to resist bursting when being formulated or otherwise subjected to mechanical stress.

“Thermal stability” as used herein, with reference to a microcapsule, means the propensity of a microcapsule to resist premature release of the microcapsules' contents when heated at a temperature below the typical degradation temperature of the microcapsules' shell-forming component such as polyurea (e.g., about 250° C.). The microcapsules disclosed herein exhibit favorable thermal stability and can be visualized using fluorescent-labeling (FITC at the core and Rhodamine 6G at the shell).

“Unfavorable leakage” as used herein, with reference to a microcapsule, means the amount of core material of a microcapsule that permeates through the shell of the microcapsule or the propensity of the microcapsule to adventitiously burst during formulation leading to premature cure. Because all polymer materials allow diffusion of small molecules at various rates, unfavorable leakage is best approximated in the context of the system disclosed herein with respect to shelf-life (i.e., greater shelf life is a result of less unfavorable leakage).

In one embodiment, a plurality of on-demand activation-type microcapsules include a shell and core structure. The shell of the microcapsules includes a polymer matrix structured for providing an extended shelf-life to the microcapsules, and the core of the microcapsules includes an active material.

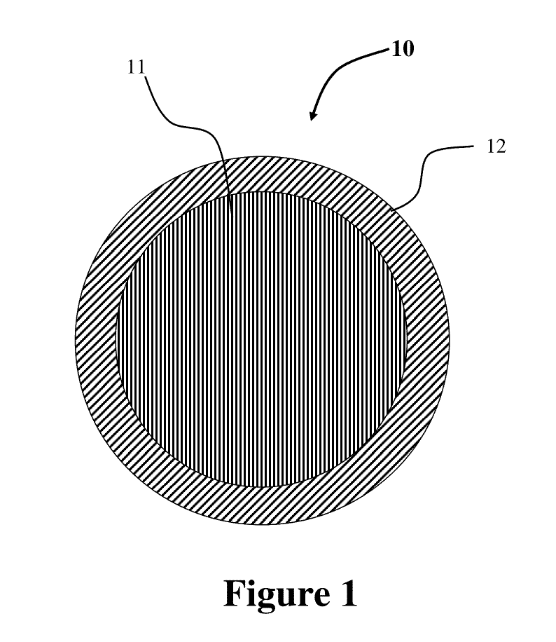

Referring now to FIG. 1, there is shown a microcapsule, indicated generally by reference numeral 10, which includes a core 11 of an active material and a shell 12 encapsulating the core 11. In one non-illustrated embodiment, inorganic particles may be incorporated in shell 12. In some forms of this embodiment, the particles can be completely embedded (encapsulated) in the body of shell 12. In other forms, the particles can be partially encased in the shell 12. In these forms for example, the particles can protrude from the body of the shell 12 through the top surface of the shell 12, the particles can protrude from the body of the shell 12 through the bottom surface of the shell into the core 11, or the particles can protrude from the shell 12 in both manners.

The core of the microcapsules disclosed herein includes one or more highly polar liquids including one or more active materials. The core is in essence the droplets formed during the emulsification or suspension of the highly polar liquid in a nonpolar liquid. Upon formation of the core and shell structure of the microcapsules, the resultant core of the microcapsules includes an active material and the highly polar liquid.

The highly polar liquid may include, for example, liquids containing one or more active hydrogen atom containing groups, ethers, thioethers, sulphoxides, oxiranes, anhydrides, esters, and mixtures thereof. For example, the highly polar liquid may include water, amines, polyamines, alcohols, glycol ethers, amino alcohols, amides, DMSO and mixtures thereof. In one more particular embodiment, the highly polar liquid can be water, methanol, glycerol, ethylene glycol, dimethyl formamide dimethyl sulfoxide or mixtures thereof.

The active material of the core includes for example a first small molecule amine compound. Generally, the first small molecule amine compound can be any amine having less than 12 carbon atoms in one embodiment and from about 13 carbon atoms to about 40 carbon atoms in another embodiment.

The first small molecule amine compound can be selected from the following compounds: ethylene diamine, diethylene triamine, triethylene tetramine, tetraethylene pentamine and mixtures thereof. Specific examples of the first amine compound as the active material may include aliphatic amines, such as ethylenediamine, diethylenetriamine, triethylenetetramine, tetraethylenepentamine, 1,3-propylenediamine, and hexamethylenediamine; epoxy compound addition products from aliphatic polyamines, such as poly(1 to 5)alkylene(C2 to C6) polyamine-alkylene(C2 to C18) oxide addition products; aromatic polyamines, such as phenylenediamine, diaminonaphthalene, and xylylenediamine; alicyclic polyamines such as piperazine; and heterocyclic diamines such as 3,9-bis-aminopropyl-2,4,8,10-tetraoxaspiro-[5.5]undecane. In one particular form, the polyamine is selected from polyethyleneimine, tetraethylenepentamine, diethylenetriamine, 2-amino etylethanolamine, ethylene diamine, triethylene tetramine, piperazine, aminoethyl piperazine, and the like or combinations thereof. In one aspect, the polyamine does not contain a hydrophobic group, for instance a cycloaliphatic group, an aromatic group or a carbon chain of 6 carbons or greater, or if present the hydrophobic group does not contain an electron withdrawing group.

In one embodiment, the first amine compound active material functions as a curing agent for a prepolymer or thermosetting resin, such as an epoxy resin, polyurethane, polyurea, aminoplast, thiourea and the like.

Generally, the concentration of the active material present in the core of the microcapsules may be for example, from about 20 weight percent (wt %) to about 40 wt % in one embodiment, from about 10 wt % to about 50 wt % in another embodiment; from about 1 wt % to about 60 wt % in still another embodiment, and from about 0.1 wt % to about 60 wt % in yet another embodiment. It is also contemplated that the active material may be present in the core in an amount above 60 wt %, although in some instances the polar liquid does not have enough surface tension with the nonpolar continuous liquid to form the necessary emulsion when the active material is present in this amount. In addition, forms where the active material may be present in the core in an amount below 0.1 wt % are contemplated, although in some instances there may not be enough active to assist in the curing process when the active material is present in this amount.

In the microcapsules disclosed herein, the shell of the microcapsules includes a polymer matrix that can be formed at the interface of droplets of highly polar liquid and nonpolar liquid after emulsification. In one aspect, the polymeric shell stabilizes the droplets of the highly polar liquid in the nonpolar liquid and imparts a desired barrier property to the transmission of active material through the shell. The polymer matrix of the shell can be formed, for example, by an interfacial polymerization process.

The shell of the microcapsules can include a polymer matrix adapted for providing a shelf-life to the microcapsules of generally greater than about 14 days in one embodiment, greater than about 21 days in another embodiment, greater than 30 days in still another embodiment, greater than 35 days in yet another embodiment, and greater than 40 days in even still another embodiment. In other embodiments, the shelf-life of the microcapsules can range from about 14 days to about 45 days, from about 14 days to about 40 days, or from about 14 days to about 38 days.

In one form, the shell comprises a polymer matrix which is essentially a reaction product of:

(a) an emulsion or suspension of a highly polar liquid in a non-polar liquid, where the highly polar liquid exists in the form of discrete droplets dispersed in the non-polar liquid, and where the highly polar liquid includes a mixture of:
(i) a first small molecule amine compound including at least one amine having from 1 to 10 carbon atoms, and
(ii) a second amine compound including at least one poly(allylamine) having greater than 100 carbon atoms; and

(b) a shell-forming compound introduced into the emulsion or suspension such that the shell-forming compound reacts with the second amine compound to form a polymeric shell about the droplets of highly polar liquid and to produce a plurality of microcapsules which may be utilized, for example, for on-demand activation.

In one embodiment, the polymer can be formed via interfacial polymerization as described in International Patent Publication No. WO 2012/166884 A2, the content of which is incorporated herein by reference in its entirety.

For example, the second amine compound which includes the at least one poly(allylamine) is a polymer-forming component that is located in the polar phase which is reacted with a relatively non-polar polymer forming component located in the nonpolar phase or introduced into the nonpolar phase of an emulsion or suspension.

In one embodiment, the poly(allylamine) may include for example a poly(allylamine) having the following chemical structure (I):

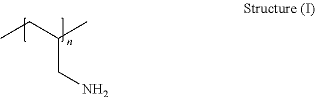

wherein n is a numeral from about 100 to about 2000.

Generally, the molecular weight (Mw) of the poly(allylamine) can range from about 1,000 Da to about 100,000 Da in one embodiment, from about 5,000 Da to about 80,000 Da in another embodiment, and from about 10,000 Da to about 65,000 Da in still another embodiment, although other variations are contemplated.

The polymer of the shell may be prepared by interfacial polymerization and in one embodiment, the shell comprises one or more polyureas which can include for example, the condensation product of a polar (hydrophilic) poly(allylamine) and a nonpolar polyisocyanate.

The microcapsules disclosed herein can have an average largest diameter size sufficient for the ultimate use of the microcapsules and which contains a sufficient amount of active material for the desired use. For example, in one form the size of the microcapsules containing a curing agent active material can be from about 50 nanometers or greater. In another form, the size of the microcapsules can be from about 500 nanometers or greater. In yet another form, the size of the microcapsules can be from about 5,000 nanometers or greater. In still another form, the size of the microcapsules is about 500,000 nanometers or less. In another form, the size of the microcapsules is 50,000 nanometers or less. In yet another form, the size of the microcapsules is about 10,000 nanometers or less.

In one form, the shell is of sufficient thickness and modulus to provide the desired strength of the microcapsules and to provide the desired barrier properties to prevent the active material and/or highly polar liquid from leaking out through the shell. In one embodiment, the shell may have a thickness sufficient to prevent passage of the highly polar liquid and/or the active material through the shell. For example, the shell thickness can be 10 microns or less in one embodiment and 1 micron or less in another embodiment.

Optionally, the polymer shell may contain particles. When the shell contains particles, the particles can be any particles that stabilize the droplets of the highly polar liquid in the polar liquid and/or which promote or impart (in whole or in part) the desired properties to the shell. In one embodiment, the particles are solid. The shape and aspect ratio of the particles can be any shape or aspect ratio that promote or provide (in whole or in part) desired properties to the shells, including platy, acicular (needle-like) or spherical particles.

The particles can be inorganic, organic or have both an organic and an inorganic component. Exemplary inorganic particles include metals; metal alloys; metal salts; metal oxides; metal sulfides; synthetic and naturally occurring minerals; clays; any of the other inorganic particles described in International Patent Publication No. WO 2012/166884 A2; and mixtures of one or more of the above particles.

The particles may include organic particles such as polymer particles of an appropriate organic material and size which promote or provide (in whole or in part) desired properties of the microcapsule. For example, the organic polymer particles can include crosslinked latex particles, and any of the organic polymers described in International Patent Publication No. WO 2012/166884 A2.

Alternatively, the particles may include inorganic particles modified with organic materials to improve the properties of the particle. In one embodiment, the particles include a mineral such as a nanoclay which is modified with an organic compound.

For example, such modified inorganic particles may include nanoclays modified on their surfaces with an onium compound such as particles commercially available from Southern Clay products under the trade names and designations of CLOISITE 20A, CLOISITE 30B, CLOISITE 10A and CLOISITE 93A nanoclays; and any of the modified particles described in International Patent Publication No. WO 2012/166884 A2.

The microcapsules may contain other materials that are present in the emulsion or dispersion during microcapsule formation provided that such materials do not impact or deleteriously affect the active materials or the function of the microcapsules. For example, the other optional materials can include emulsifiers, surfactants, stabilizers and the like.

As aforementioned, the process for preparing the microcapsules disclosed herein includes for example an interfacial polymerization process as described in International Patent Publication No. WO 2012/166884 A2.

In general, one non-limiting process for producing these microcapsules, which may be used for on-demand activation-type systems for example, includes the following steps:

(a) contacting a non-polar liquid with a highly polar liquid adapted for forming an interface of an emulsion or suspension of the highly polar liquid in the nonpolar liquid;

(b) emulsifying the contacted liquids to form an emulsion or suspension of the highly polar liquid in the non-polar liquid such that discrete droplets of the highly polar liquid are formed in the non-polar liquid, the highly polar liquid including a mixture of (i) a first small molecule amine compound including at least one amine having from 1 carbon atom to about 10 carbon atoms, and (ii) a second amine compound including at least one poly(allylamine) having greater than 10 carbon atoms in one embodiment, greater than about 100 carbon atoms in another embodiment, and greater than about 1000 carbon atoms in still another embodiment; and

(c) forming the polymer matrix by introducing a shell-forming compound into the emulsion or suspension such that the shell-forming compound reacts with the second amine compound to form a polymeric shell about the droplets of highly polar liquid and produce a plurality of on-demand activation-type microcapsules each including a shell and core structure, the shell of the microcapsules including a polymer matrix structured for providing an extended shelf-life to the microcapsules and the core of the microcapsules including an active material (including the first small molecule amine compound) and/or the highly polar liquid.

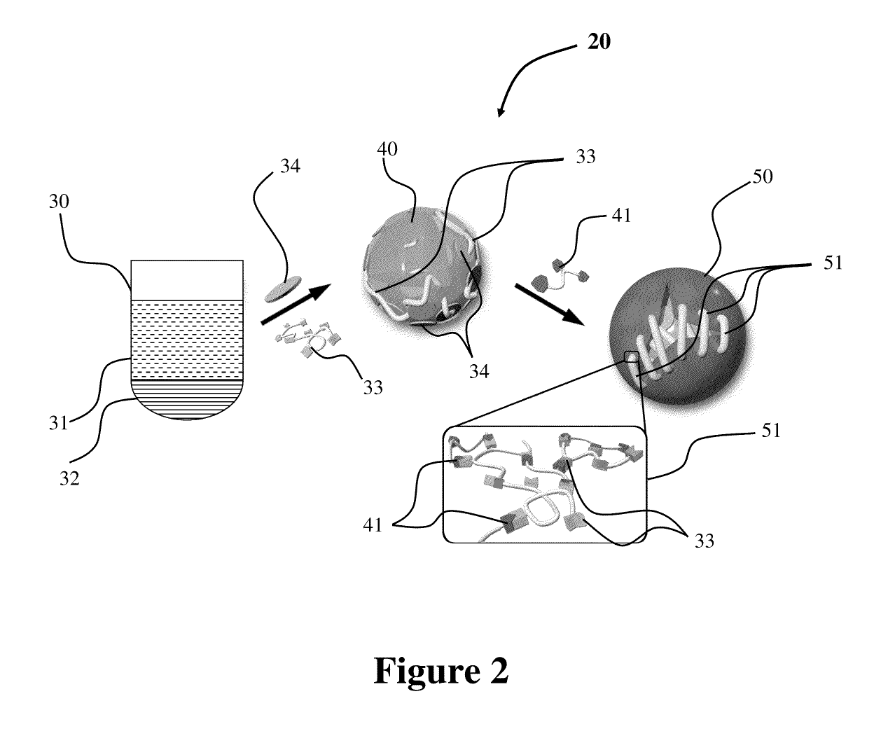

With reference to FIG. 2, there is illustrated a schematic view of one non-limiting encapsulation method generally indicated by reference numeral 20. The method 20 involves a reaction vessel 30, intermediate (precursor) discrete droplets 40, and functionalized microcapsules 50. Vessel 30 contains the two reaction solutions of a non-polar liquid 31 and a highly polar liquid 32 which are emulsified to form an interface of an emulsion or suspension of the highly polar liquid in the nonpolar liquid as discrete droplets. The liquid 32 can include in part the first small amine and in part water, and a shell-life extending, shell-forming compound 33 (second amine) can be added to the reaction solution in vessel 30. Optionally, inorganic particles such as nanoclay particles 34 can also be added to the emulsion in vessel 30. The discrete droplets 40 include the amine 33 and the particles 34, as well as the highly polar liquid 32. Then, a shell-forming compound 41, such as an isocyanate, can be added to the emulsion to polymerize and form a hard polymeric shell encapsulating the core material resulting in the microcapsule 50 having a shelf-life extending shell 51. The shell 51 of the microcapsule 50 has an extended shelf-life and includes the reaction between the amine compound 33 and the compound 41 depicted in the enlarged portion 51 of FIG. 2.

The first small molecule amine compound (active material) and the second amine compound which includes at least one poly(allylamine) (polar polymerizable component) can be dissolved, suspended or dispersed in the one or more highly polar liquids using standard techniques for dissolving or dispersing components in a liquid such as by known means of agitation.

The nonpolar liquids and the highly polar liquids are contacted and exposed to conditions such that an emulsion or suspension is prepared. The nonpolar liquids form the continuous phase and the highly polar liquids form the discontinuous phase. This is known as an inverse emulsion or suspension. The contacted liquids are subjected to one or more forms of agitation and or shear to form the desired emulsion or suspension. Agitation and shear can be introduced through the use of impellers, ultrasonication, rotor-stator mixers and the like. For industrial-scale production of emulsions or suspensions it is advisable to pass the mixture of nonpolar and highly polar liquids a number of times through a shear field located outside a reservoir/polymerization vessel until the desired droplet size has been reached. Exemplary apparatuses for generating a shear field are comminution machines which operate according to the rotor-stator principle, e.g., toothed ring dispersion machines, colloid mills and corundum disk mills and also high-pressure and ultrasound homogenizers. To regulate the droplet size, it can be advantageous to additionally install pumps and/or flow restrictors in the circuit around which the emulsion or suspension circulates.

Once a stable emulsion or suspension is formed the emulsion or suspension is subjected to polymerization conditions so as to form a polymer, such as a polymer shell about the droplets of highly polar liquid. The conditions for polymerization are based on the choice of the polymer utilized. Any polymer system and associated process for preparation may be used which forms a polymer or deposits or forms the polymer as a shell about the droplets. Exemplary processes include interfacial polymerization, in-situ polymerization, precipitation of the polymer from the polar or nonpolar phase and electrostatic deposition, such as by coacervation or layer-by layer deposition.

In one embodiment, the polymer is formed by interfacial polymerization. Typically, in interfacial polymerization a polar (or hydrophilic) polymer forming component is located in the highly polar liquid phase and a non-polar (hydrophobic) polymer forming component is located in the non-polar liquid. Other components that impact or enhance the polymerization can be added to one or the other of the highly polar liquid or nonpolar liquid based on the relative polarity (hydrophilicity or hydrophobicity) of the ingredient, examples of such additives including catalysts, accelerators, initiators, fillers, crosslinking agents, chain extenders, gelling agents, and the like.

The polymerization is initiated by exposing the emulsion or suspension to conditions at which the polymerization proceeds. Examples of this include adding ingredients, catalysts, initiators, accelerators, and the like; exposing the emulsion or suspension to temperatures at which polymerization proceeds at a reasonable rate; and the like. Such temperatures can be sub-ambient, ambient or super-ambient. In the embodiment where the polymerization proceeds at room temperature or lower, such as for some reactions of polyisocyanates with compounds containing active hydrogen containing groups, one of the ingredients may be added after emulsification. In this embodiment, the nonpolar (hydrophobic) component may be added after a stable emulsion or suspension is formed because the continuous phase is nonpolar. Generally interfacial polymerization stops when the polymerizable components can no longer contact each other. In one embodiment, this occurs when the polymer shell effectively forms a barrier around the droplets.

In embodiments utilizing interfacial polymerization, the prepared polymers may include polyureas, polyurethanes and polyurea-urethanes, which are generally prepared from reacting a polyisocyanate compound and one or more compounds that react with the polyisocyanate compound.

The polyisocyanate compounds can be generally nonpolar and dissolve or disperse in the nonpolar solvent. The polyisocyanate compounds can be any polyisocyanate having more than one isocyanate group per molecule and, in particular forms, two or more isocyanate groups per molecule. In one aspect, the polyisocyanates have 4 or less isocyanate groups per molecule and, in a further aspect, 3 or less isocyanate groups per molecule. These aspects assume perfect reaction and ignore byproduct formation and are based on theoretical numbers of isocyanate groups that can be derived from the stoichiometry of the formation of such compounds. The polyisocyanates can be in the form of monomers or oligomers or prepolymers prepared from such monomers.

The polyisocyanates which may be used for production of the microcapsules disclosed herein include, for example, any aliphatic, cycloaliphatic, araliphatic, heterocyclic or aromatic polyisocyanates, or mixtures thereof. In one form, the polyisocyanates used have an average isocyanate functionality of at least about 2.0 and an equivalent weight of at least about 80. In another aspect, the isocyanate functionality of the polyisocyanate is at least about 2.4 and is no greater than about 4.0. Higher functionality may also be used. In one aspect, the equivalent weight of the polyisocyanate is at least about 110 and is no greater than about 300. Examples of exemplary polyisocyanates include those disclosed in U.S. Pat. No. 6,512,033 to Wu at column 3, line 3 to line 49, the content of which is incorporated herein by reference in its entirety. In one form, the isocyanates utilized are aromatic isocyanates, alicyclic isocyanates and derivatives thereof. In some forms, the aromatic isocyanates have the isocyanate groups bonded directly to aromatic rings. Additional exemplary polyisocyanates include diphenylmethane diisocyanate and oligomeric or polymeric derivatives thereof, isophorone diisocyanate, tetramethylxylene diisocyanate, 1,6-hexamethylene diisocyanate and polymeric derivatives thereof, bis(4-isocyanatocylohexyl)methane, and trimethyl hexamethylene diisocyanate. In one particular but non-limiting form, the isocyanate is diphenylmethane diisocyanate and oligomeric or polymeric derivatives thereof. The amount of isocyanate containing compound used to prepare the prepolymer is that amount which promotes or provides (in whole or in part) the desired properties such as shell thickness, morphology, and shelf-life.

The other polymerizable component reacted with the polyisocyanate compound is the poly(allylamine) compound. In one form, the poly(allylamine) compound (polar polymerizable component) dissolves or disperses in the highly polar liquid.

In one exemplary form, the poly(allylamine) compound utilized in production of the microcapsules disclosed herein has a molecular weight of about 15,000. One or more catalysts, initiators, gelling agents, crosslinking agents or chain extenders may be included in either the nonpolar phase or the highly polar phase.

After the polymer shells are formed on the droplets the microcapsules may be recovered by any known technique that does not substantially compromise the microcapsules. Exemplary processes for recovery of the microcapsules include filtration of the microcapsules from the continuous phase, precipitation, spray drying, decantation, centrifugation, flash drying, freeze drying, evaporation, distillation and the like. In one aspect, the separation process is selected to effect a rapid and efficient separation while minimizing mechanical damage to or disruption of the microcapsules.

As indicated above, the microcapsules disclosed herein may exhibit extended shelf-life properties. In one aspect for example, these properties extend the shelf-life of the microcapsules from about 1 day to about 3 months.

The microcapsules disclosed herein can be used in any application in which conventional microcapsules are used. For example, the microcapsules disclosed herein may be used as a component in a curable composition, which in turn, can be used to manufacture a cured thermoset product for various end uses such as coatings, adhesives, and composites.

For example, in one embodiment, a curable epoxy resin composition is prepared by mixing (a) a plurality of the microcapsules described herein with (b) at least one epoxy monomer compound to form the curable composition.

The epoxy monomer can include, for example, commercially available epoxy resins such as DER™ 331 available from The Dow Chemical Company.

Optional components that can be added to the curable composition include for example catalysts, inert filler, and the like.

In this embodiment, the curable composition can be used to produce a cured epoxy resin composite by applying an activation stimuli to the microcapsules of the curable composition such that the shells of the microcapsules rupture and the active material curing agent from the core of the microcapsules contacts the epoxy monomer compound to form a curable reaction mixture. The curing agent from the microcapsule uniformly diffuses throughout the epoxy resin network upon the microcapsule shell rupturing. The resultant reaction mixture of the epoxy resin and diffused curing agent can then be heated at a curing temperature sufficient to cure the reaction mixture to form a cured epoxy resin composite. The curing temperature can be from about 0° C. to about 250° C. in one embodiment and from about 10° C. to about 40° C. in another embodiment, although other variations are contemplated.

The activation stimuli for rupturing the shell of the microcapsules can be, for example, a shearing force. In one aspect, the microcapsules disclosed herein are sufficiently robust to withstand the shearing forces of formulation, shipping and handling, and the shearing force of activation may be any force that is above this threshold, which may differ according to the final application of the microcapsules. As an illustration, and not to be bound thereto, one example of a shearing force applied to rupture the microcapsules can be for example the shearing force of a 1 cm rotor stator homogenizer spinning at 1000 rpms for 1 minute when applied to an approximately 10 g sample of microcapsules in epoxy resin.

### EXAMPLES

The following examples and comparative examples further illustrate the present invention in detail but are not to be construed to limit the scope thereof.

Various terms and designations used in the following examples are explained herein below:

“pAAM” stands for poly(allylamine).

“TEPA” stands for tetraethylene pentamine.

“PIB” stands for polyisobutylene.

“PMDI” stands for polymeric methylene diphenyl isocyanate.

“TGA” stands for thermogravimetric analysis.

“DSC” stands for differential scanning calorimetry.

“FITC” stands for fluorescein isothiocyanate.

Cloisite 20 is a hydrophobically-modified clay nano-platelet product commercially available from Southern Clay Products.

D.E.R™ 331 is an epoxy resin, (2,2′-(((propane-2,2-diylbis(4,1-phenylene))bis(oxy))bis-(methylene))bis(oxirane)), having an epoxy equivalent weight (EEW) of 182-192 and commercially available from The Dow Chemical Company.

### Comparative Example A

### Pickering Emulsion-Templated Microcapsules

In this Comparative Example A, Pickering emulsion-templated microcapsules were formulated as described in International Patent Publication No. WO 2012/166884 A2 using the following procedure: 10 grams (g) xylene (with 1.3 parts per hundred [pph] PIB), 1 g TEPA and 2 g water were mixed and stirred at 500 revolutions per minute (rpm) for 2 minutes (min) as premixing. Then, 0.167 g xylene solution containing 0.008 g Cloisite 20 was added to the premix and the resultant mixture was stirred at 500 rpm for 2 min. The mixture was then ultra-sonicated using Sonics VCX 500 Watt sonication with a full size (1.27 centimeter [cm] diameter) probe at 50% power for 25 seconds(s) (including a pause of 1 s after each 5 s of sonication) to generate an inverse Pickering emulsion. The resulting emulsion was stirred at 1500 rpm for 2 min. Then, 1.67 g xylene solution containing 0.067 g PMDI was quickly added to the emulsion. After fast adding (e.g., the addition takes less than 10 s) the PMDI solution to the emulsion, the stir rate of the emulsion was decreased to 500 rpm for 1 min. The resulting suspension was quenched with excess bis(2-ethylhexyl)amine xylene solution to form dispersible microcapsules. The suspension was then washed, three times, with 10 g xylene; and dried under mild vacuum filtration.

### Example 1

### Microcapsule-Epoxy Compositions

In this example, Pickering emulsion-templated microcapsules were formulated as described in International Patent Publication No. WO 2012/166884 A2, but with the addition of the poly(allylamine) additive, using the following procedure: 10 g xylene (with 1.3 pph PIB), 1 g TEPA, 2 g water, and pAAM (loadings varied between 10 mg and 200 mg) were mixed and stirred at 500 rpm for 2 min as premixing. Then, 0.167 g xylene solution containing 0.008 g Cloisite 20 was added to the premix and the resultant mixture was stirred at 500 rpm for 2 min. The mixture was then ultra-sonicated using Sonics VCX 500 Watt sonication with a full size (1.27 cm diameter) probe at 50% power for 25 s (including a pause of 1 s after each 5 s of sonication) to generate an inverse Pickering emulsion. The resulting emulsion was stirred at 1500 rpm for 2 min. Then, 1.67 g xylene solution containing 0.067 g PMDI was quickly added to the emulsion. After fast adding (e.g., the addition takes less than 10 s) the PMDI solution to the emulsion, the stir rate of the emulsion was decreased to 500 rpm for 1 min. The resulting suspension was quenched with excess bis(2-ethylhexyl)amine xylene solution to form dispersible microcapsules. The suspension was then washed, three times, with 10 g xylene; and dried under mild vacuum filtration.

### Viscosity Measurements

The viscosity change of a standard microcapsule-epoxy composition was measured to establish a representative example for microcapsules of the prior art. “Standard” microcapsules herein refer to the microcapsules fabricated as described in International Patent Publication No. WO 2012/166884 A2 and Comparative Example A above. The viscosity of the microcapsule-epoxy compositions, both standard and those formulated as disclosed herein, was obtained using a Brookfield DV-I PRIME viscometer with a 64# spindle at 12 rpm for viscosity lower than 50 Pa*s and 1 rpm for viscosity higher than 50 Pa's.

The activation of microcapsules was achieved using an OMNI GLH homogenizer with a 10 mm×95 mm Saw Tooth (Fine) Generator Probe operated at 10,000 rpm for 60 s. The TEPA/water-loaded microcapsules displayed a fast release behavior when mixed with liquid epoxy, D.E.R 331.

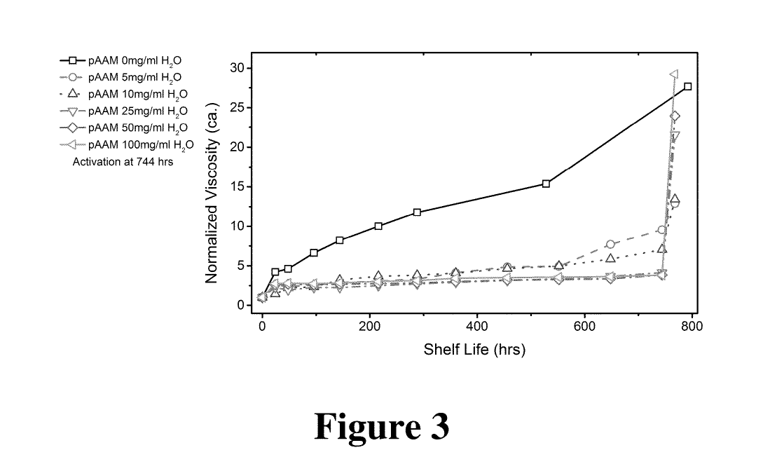

The initial viscosity of the standard microcapsule-epoxy composition was measured immediately after mixing the microcapsules and epoxy resin. A viscosity change of approximately 12 times of the composition's initial viscosity was observed after 300 hr of storage time of the composition (see the dark solid line in FIG. 3). The viscosity of the composition after 300 hr of storage is almost equal to the resultant viscosity of a fully-ruptured amine-epoxy composition mixture, which can be achieved by completely rupturing the microcapsules by applying high shear force (see dashed line and light grey line in FIG. 3). When the results shown by the dark solid line are compared to the long dash line, this comparison reveals that the standard amine-core microcapsules undergo release of actives during storage.

The viscosity trend of a mixture of (a) TEPA-loaded microcapsules, (b) D.E.R. 331 epoxy, and (c) various different loading of pAAM, was monitored (i) during storage and (ii) after activation of the microcapsules at 744 hr. The loading of pAAM in microcapsules produced according to the process disclosed herein was varied from 5 mg/mL to 100 mg/mL in water.

Addition of pAAM with 5 mg/mL or higher concentration in water considerably decreased the rate of release, so that the normalized viscosity of the mixture remained below “5” after 500 hr of storage as shown in FIG. 3.

The foregoing is illustrative of the present invention, and is not to be construed as limiting thereof. The invention is defined by the following claims, with equivalents of the claims to be included therein.

What is claimed is:

1. A microcapsule, comprising a shell and core structure, wherein the shell of the microcapsule comprises a polymer matrix comprising a reaction product of:
(a) an emulsion or suspension of a highly polar liquid in a non-polar liquid, wherein the highly polar liquid exists in the form of discrete droplets dispersed in the non-polar liquid, and wherein the highly polar liquid includes a mixture of (i) a first small molecule amine compound comprising at least one amine having from 1 to 6 carbon atoms, and (ii) a second amine compound comprising at least one poly(allylamine) having greater than 6 carbon atoms; and
(b) a shell-forming compound introduced into the emulsion or suspension and reacting with the second amine compound to form a polymeric shell about the droplets of highly polar liquid and to produce the microcapsules; and
wherein the core of the microcapsule comprises the first small molecule amine compound and the highly polar liquid.

2. The microcapsule of claim 1, wherein the permeability of the shell is sufficient to prevent or minimize passage of the first small molecule amine compound and the highly polar liquid from the core through the shell and to provide an extended shelf-life to the microcapsule.

3. The microcapsule of claim 1, wherein the first small molecule amine compound is tetraethylene pentamine.

4. The microcapsule of claim 1, wherein the concentration of the first small molecule amine compound in the core is from about 1 weight percent to about 50 weight percent.

5. The microcapsule of claim 1, wherein the at least one poly(allylamine) is an amine compound having the following chemical structure (I): 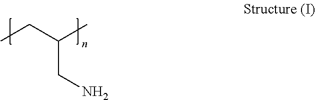
wherein n is a numeral from about 100 to about 2000.

6. The microcapsule of claim 1, wherein the first small molecule amine compound is a curing agent for a thermosetting resin.

7. The microcapsule of claim 1, wherein the shell-forming compound is a polyisocyanate.

8. The microcapsule of claim 1, wherein the concentration of the shell-forming compound is from about 0.1 weight percent to about 25 weight percent.

9. The microcapsule of claim 1, wherein the polymer matrix is a polyurea, polyurethane, polyurea-urethane or a mixture thereof.

10. The microcapsule of claim 1, wherein the shell further comprises a plurality of particles in contact with the polymer matrix.

11. The microcapsule of claim 10, wherein the plurality of particles includes one or more nanoclays.

12. The microcapsule of claim 1, wherein the microcapsules exhibit a particle size of about 50 nanometers to about 500,000 nanometers.

13. The microcapsule of claim 1, wherein the highly polar liquid is selected from the group consisting of water, ethylene glycol, glycerol, methanol, dimethyl formamide, dimethyl sulfoxide, or mixtures thereof.

14. The microcapsule of claim 1, wherein the non-polar liquid is selected from the group consisting of xylene (any isomer), toluene, benzene, mineral oil, silicon oil, hexanes, heptane, pentane, cyclohexane, decalin, naphthyl spirits, or mixtures thereof.

15. A process for producing microcapsules, comprising:
(a) contacting a non-polar liquid with a highly polar liquid;
(b) emulsifying the contacted liquids to form an emulsion or suspension of the highly polar liquid in the non-polar liquid, wherein discrete droplets of the highly polar liquid are formed in the non-polar liquid, and wherein the highly polar liquid includes a mixture of (i) a first small molecule amine compound comprising at least one amine having from 1 to 6 carbon atoms, and (ii) a second amine compound comprising at least one poly(allylamine) having greater than 6 carbon atoms; and
(c) forming the polymer matrix by introducing a shell-forming compound into the emulsion or suspension in order to react the shell-forming compound with the second amine compound to form a polymeric shell about the droplets of highly polar liquid and produce a plurality of the microcapsules each including a shell and core structure; and
wherein the shell of the microcapsules comprises a polymer matrix structured for promoting an extended shelf-life to the microcapsules, and wherein the core of the microcapsules comprises one or both of the first small molecule amine compound and the highly polar liquid.

16. A curable epoxy resin composition, comprising a mixture of (a) a plurality of microcapsules of claim 1; and (b) at least one epoxy monomer compound.

17. A process for producing a curable epoxy resin composition, comprising admixing (a) a plurality of microcapsules of claim 1 and (b) at least one epoxy monomer compound.

18. A process for producing a cured epoxy resin composite, comprising:
(a) admixing (i) a plurality of the microcapsules of claim 1 and (ii) at least one epoxy monomer compound to form a curable composition;
(b) applying an activation stimuli to the curable composition of (a) for rupturing the shells of the microcapsules and releasing the active material from the core of the microcapsules to contact the epoxy monomer compound to form a reaction mixture; and
(c) heating the resultant reaction mixture of (b) at a temperature sufficient to cure the reaction mixture of (b) to form a cured epoxy resin composite.

19. The process of claim 18, wherein the activation stimuli of (b) involves application of a shearing force.

20. The process of claim 18, wherein the heating of (c) is carried out at a temperature of from about 0° C. to about 100° C.

21. The process of claim 18, further comprising adding one or more catalysts, accelerators, initiators, fillers, crosslinking agents, chain extenders, gelling agents, and combinations thereof in one or more of steps (a)-(c).
